(19) United States
(12) Patent Application Publication
(10) Pub. No.: US 2013/0091087 A1
(43) Pub. Date: Apr. 11, 2013

(54) Systems and methods for prediction-based crawling of social media network

(71) Applicant: Topsy Labs, Inc., San Francisco, CA (US)

(72) Inventors: Vipul Ved Prakash, San Francisco, CA (US); Rishab Aiyer Ghosh, San Francisco, CA (US); Lun Ted Cui, Fremont, CA (US)

(73) Assignee: Topsy Labs, Inc., San Francisco, CA (US)

(21) Appl. No.: 13/648,005

(22) Filed: Oct. 9, 2012

Related U.S. Application Data
(60) Provisional application No. 61/545,527, filed on Oct. 10, 2011.

(51) Int. Cl. G06N 5/02

(52) U.S. Cl. 706/50

(57) ABSTRACT

A new approach is proposed that contemplates systems and methods to support efficient crawling of a social media network based on predicted future activities of each user on the social network. First, data related to a user's past activities on a social network are collected and a pattern of the user's past activities over time on the social network is established. Based on the established pattern on the user's past activities, predictions about the user's future activities on the social network can be established. Such predictions can then be used to determine the collection schedule—timing and frequency—to collect data on the user's activities for future crawling of the social network.

### RELATED APPLICATIONS

This application claims priority to U.S. Provisional Patent Application No. 61/545,527, filed Oct. 10, 2011, and entitled “Systems and methods for prediction-based crawling of social media network,” and is hereby incorporated herein by reference.

### BACKGROUND

Web crawling refers to software-based techniques that browse the World Wide Web in a methodical, automated manner or in an orderly fashion. Web crawlers are mainly used to create a copy of all the visited pages for later processing by a search engine that will collect and index the downloaded pages to provide fast searches. Crawlers can also be used for automating maintenance tasks on a Web site, such as checking links or validating HTML code. In general, a Web crawler starts with a list of URLs to visit, called the seeds. As the crawler visits these URLs, it identifies all the hyperlinks in the page and adds them to the list of URLs to visit, called the crawl frontier. URLs from the frontier are recursively visited according to a set of policies.

Social media networks such as Facebook and Twitter have experienced exponential growth in recently years as web-based communication platforms. Hundreds of millions of people are using various forms of social media networks everyday to communicate and stay connected with each other. Consequently, the resulting activity data from the users on the social media networks becomes phenomenal and using the traditional web crawling techniques to explore the activity data of each and every user on the social media network on a regular basis becomes prohibitively expensive and infeasible in terms of the time and resources required. Practically, any web crawler is only able to collect and download a fraction of the user activities on the social media network within a given time, while the high rate of activities of active users on the social media network demand that their data be collected frequently before they are updated or deleted. There is an increasing need for a crawling approach specific tailored for social media network that is efficient and timely in order to keep the collected data “fresh.”

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support prediction-based social media network crawling.

FIG. 2 depicts an example of a flowchart of a process to support prediction-based social media network crawling.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support efficient crawling of a social media network based on predicted future activities of each user on the social network. First, data related to a user's past activities on a social network are collected and a pattern of the user's past activities over time on the social network is established. Based on the established pattern on the user's past activities, predictions about the user's future activities on the social network can be established. Such predictions can then be used to determine the collection schedule—timing (when) and frequency—to collect data on the user's activities for future crawling of the social network. Such prediction-based social media network balances between efficiency and “freshness” of social network crawling by avoiding time and resource exhaustive crawling of the social network for activities of every user every time even when some of them are inactive, while still collecting fresh data from each user at his/her predicted active time in a timely manner.

As referred to hereinafter, a social media network, or simply social network, can be any publicly accessible web-based platform or community that enables its users/members to post, share, communicate, and interact with each other. For non-limiting examples, such social media network can be but is not limited to, Facebook, Google+, Tweeter, LinkedIn, blogs, forums, or any other web-based communities.

As referred to hereinafter, a user's activities on a social media network include but are not limited to, tweets, posts, comments to other users' posts, opinions (e.g., Likes), feeds, connections (e.g., add other user as friend), references, links to other websites or applications, or any other activities on the social network. In contrast to a typical web content, which creation time may not always be clearly associated with the content, one unique characteristics of a user's activities on the social network is that there is an explicit time stamp associated with each of the activities, making it possible to establish a pattern of the user's activities over time on the social network.

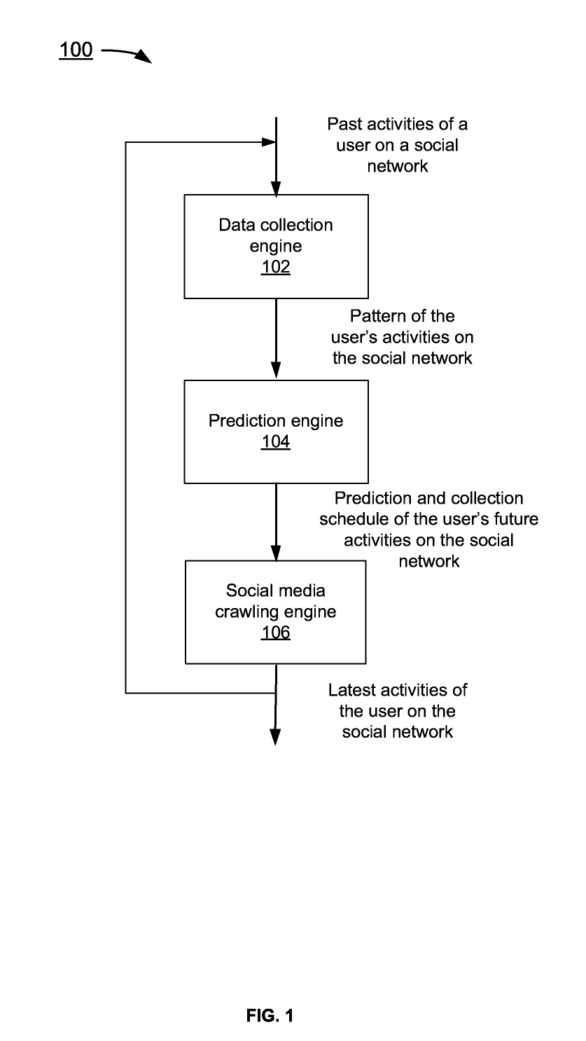

FIG. 1 depicts an example of a system diagram to support prediction-based social media network crawling. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least data collection engine 102, prediction engine 104, and social media crawling engine 106. As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the engines can run on one or more hosting devices (hosts). Here, a host can be a computing device, a communication device, a storage device, or any electronic device capable of running a software component. For non-limiting examples, a computing device can be but is not limited to a laptop PC, a desktop PC, a tablet PC, an iPod, an iPhone, an iPad, Google's Android device, a PDA, or a server machine. A storage device can be but is not limited to a hard disk drive, a flash memory drive, or any portable storage device. A communication device can be but is not limited to a mobile phone.

In the example of FIG. 1, data collection engine 102, prediction engine 104, and social media crawling engine 106 each has a communication interface (not shown), which is a software component that enables the engines to communicate with each other following certain communication protocols, such as TCP/IP protocol, over one or more communication networks (not shown). Here, the communication networks can be but are not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, data collection engine 102 gathers past activities of each user on a social network. The past activities of the user may have been collected during previous crawling of the social network by social media crawling engine 106 over a certain period of time and maintained in a database as past activity records associated with the user. Once the past activities of the user are collected, data collection engine 102 may establish an activity distribution pattern/model for the user over time based on the timestamps associated with the activities of the user. Such activity distribution pattern over time may reflect when the user is most or least active on the social network and the frequency of the user's activities on the social network. For a non-limiting example, the user may be most active on the social network between the hours of 8-12 in the evenings while may be least active during early mornings, or the user is most active on weekends rather than week days.

In some embodiments, data collection engine 102 may also determine whether the user is likely to be most active upon the occurrence of certain events, such as certain sports event or news the user is following. Alternatively, data collection engine 102 may determine that the user's activities are closely related to the activities of one or more his/her friends the user is connected to on the social network. For a non-limiting example, if one or more of the user's friends become active, e.g., starting an interesting discussion or participating in an online game, it is also likely to cause to user to get actively involved as well.

In the example of FIG. 1, prediction engine 104 makes predictions on the user's future activities on the social network based on the established pattern of the user's activities in the past. The rational behind such prediction is that a person typically has his/her own habits, routines, rituals and usually acts or behaves in a certain predictable manner. As such, a user's activity in the past can be used to predict his/her activities in the future For a non-limiting example, if the user is typically very active in the evening or weekend over the past weeks or months, it can be predicted that he/she will continue to be very active in the coming evenings and weekends.

Based on the predictions on the user's future activities, prediction engine 104 may determine a corresponding activity collection schedule for the user that balances between efficiency and freshness of the data collection. Such collection schedule directly relates to the time periods when the user is most active, i.e., activity data collection is scheduled during the time when he/she is predicted to be most active, while data collection can be skipped by social media crawling engine 106 for the user during the time when he/she is predicted to be less active by the collection schedule of the user.

In the example of FIG. 1, social media crawling engine 106 periodically crawls the social network to collect the latest activity data from each user based on the activity collection schedule for the user. If a user's activities are not to be collected at the time of the crawling according to the user's activity collection schedule, social media crawling engine 106 will skip the content related to the user and move on to the next user whose activity is to be collected according to his/her schedule. Given the vast amount of the data accessible in a social media network, such selective collection of data by social media crawling engine 106 reduces the time and resources required for each around of crawling without comprising on the freshness of the data collected. In some embodiments, social media crawling engine 106 may run and coordinate multiple crawlers coming from different Internet addresses (IPs) in order to collect as much data as possible. Social media crawling engine 106 may also maximize the amount of new data collected per (HTTP) request.

Note that there will likely be abnormalities to the typically predictable user behavior due to certain unforeseen and unpredictable events that may cause a user to adjust his/her activities and suddenly become active at times when it is predicted he/she is not. To accommodate such unforeseen and unpredictable changes in user's behavior, the entire prediction-based social media crawling process is designed to be adaptive. More specifically, in some embodiments, social media crawling engine 106 is operable to provide the latest collections of the activity data to data collection engine 102 in a timely manner. If the data collection engine 102 identifies that the activity data from certain user is not “fresh”, meaning that the user's activities happened certain time ago before they are collected, then the user's activity pattern may need to be adjusted and prediction engine 104 will update current predictions and collection schedules or make new predictions and collection schedules to reflect the changed behavior pattern of the user.

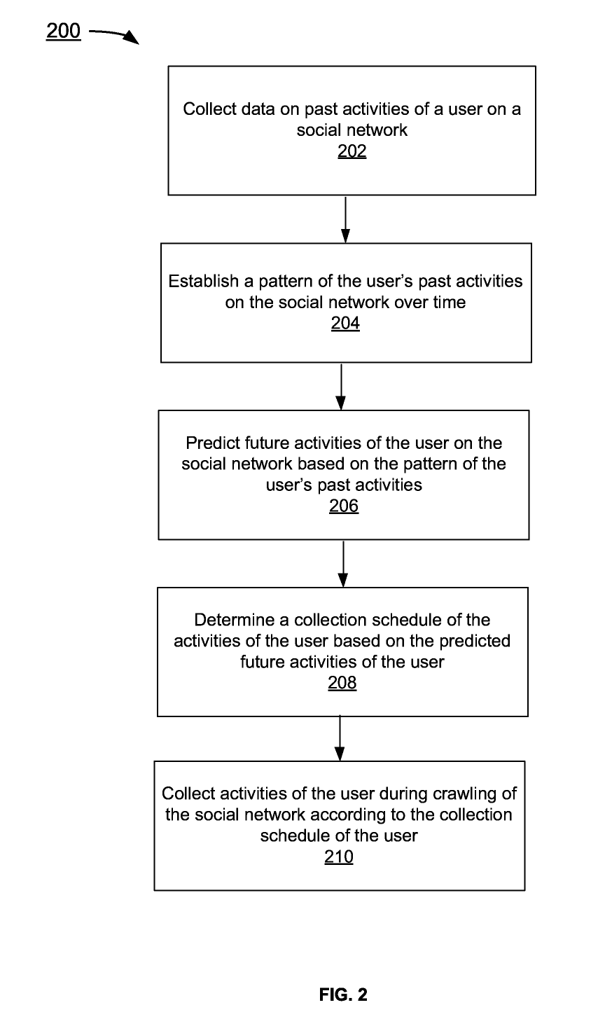

FIG. 2 depicts an example of a flowchart of a process to support prediction-based social media network crawling. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202 where data on past activities of a user on a social network is collected. The flowchart 200 continues to block 204 where a pattern of the user's past activity on the social network over time is established. The flowchart 200 continues to block 206 where future activities of the user on the social network are predicted based on the pattern of the user's past activities. The flowchart 200 continues to block 208 where a collection schedule of the activities of the user is determined based on the predicted future activities of the user. The flowchart 200 ends at block 210 where activities of the user are collected during crawling of the social network according to the collection schedule of the user.

In some embodiments, social media crawling engine 106 may collect activity data of the user on the social network by utilizing an application programming interface (API) provided by the social network. For a non-limiting example, the OpenGraph API provided by Facebook exposes multiple resources (i.e., data related to activities of a user) on the social network, wherein every type of resource has an ID and an introspection method is available to learn the type and the methods available on it. Here, IDs can be user names and/or numbers. Since all resources have numbered IDs and only some have named IDs, only use numbered IDs are used to refer to resources.

In some embodiments, social media crawling engine 106 divides its collection of data on the user's activities into two types of resources: primary objects and feeds of primary objects. Here, primary objects of interest include but are not limited to “user”, “page”, “video”, “link”, “swf”, “photo”, “application”, “status” and “comment.” Primary objects have feeds associated with them, listed in the resource above as “connections,” which can be polled to discover new primary objects. For a social network that has complex privacy settings, such as Facebook, social media crawling engine 106 may discover whether an object or feed is private by simply fetching it. For example, for a user who is public but his/her likes feed is private, the social media crawling engine 106 would receive an exception when fetching the private objects of the user. It is possible that certain types of connections (like friends) are always private and should be explicitly blacklisted.

In some embodiments, there are at least two way for social media crawling engine 106 to seed the crawl process:
1. Start the crawl process with a single seed, for a non-limiting example, techcrunch http://graph.facebook.com/techcrunch.
2. Start with a list of seeds from webpages that have the like button.
   One advantage of approach #2 is that social media crawling engine 106 may start with a higher density of public feeds to ensure that the activity data collected comprehensive but this approach comes at a higher preparation cost that approach #1.

In some embodiments, social media crawling engine 106 maintains at least three in-memory data structures for data on a user's activities:
1. Frontier: which is a list of resources (both objects and feeds) that should be retrieved for the user. This is a list of tuples (url, timestamp) and there are two types of appends to this list:

1) When a new object or feed is discovered, it is appended as (url, now);

2) Once an object is retrieved, a refresh date can be predicted for it based on the collection schedule and append to the frontier as (url, refresh_date).

In some embodiments, social media crawling engine 106 sorts and updates the frontier periodically (e.g., every 10 minutes) such that items with the earliest date are in the front. Such sort is very fast even on frontiers with tens of millions of items. The sort can also truncate the frontier since truncated items will eventually be discovered again anyway.
2. Population, which is hash of URLs that have been added to the frontier. This hash provides a way to push new objects on the frontier with a higher priority (timestamp now).
3. Corpus, which is a list of successfully retrieved resources. Social media crawling engine 106 writes the corpus to disk files/database as data on the user's activities once there are certain amount of resources in the list.

In some embodiments, the crawl process of social media crawling engine 106 fetches the top resource from the frontier with HTTP command. Social media crawling engine 106 then inspects the resource type and assign a process chain to the resource. Here, the “process chain” method is a way for social media crawling engine 106 to extend corpuses beyond Facebook for non-Facebook resources. Some typical process chains for resources are but are not limited to:

1. Private, where the resource URL is added to the population but not pushed back on the frontier so that this object is never fetched again.

2. Primary object, where the resource URL is added to population and the resource document is added to the corpus. First, an object refresh strategy can be applied to determine when to fetch the object again. For example, users change their photos often, which should be fetched every week, while videos are more static and should only be fetched once a month to see if they have been deleted. Social media crawling engine 106 computes the refresh date and push the object back on the frontier. Next, the feeds associated with this object of interests, e.g., user/likes, user/feed, user/posts, are determined. Social media crawling engine 106 pushes (feed, now) on the frontier if the feed is not in the Population.

3. Feed, which is added to the population and parsed to discover all IDs referenced in the resource. For instance, a recursive parser can find all fields with “id” key. Social media crawling engine 106 would add the resource to population (if it is not there yet) and push (resource, now) on the frontier. Since all feeds returned from a social network such as Facebook has objects and their dates in them, information such as
AVERAGE_INTERVAL in the dates can be used to predict a REFRESH_DATE using the following exemplary formula:

REFRESH_DATE=NOW+(AVERAGE_INTERVAL*NUM_ELEMENTS)

Where NUM_ELEMENTS is the number of new elements expected to be in the list since last fetch. Given that the scarcity lies in the number of calls made to Facebook, it is preferable to set this to the max number of elements returned by Facebook in one request.

4. Corpus feed, which are certain types of feeds containing primary objects that either need not be (e.g., “status/comment”) or cannot be (e.g., “link/likes”) fetched independently.

Since the frontier and population may scale to over 10 billion resources in some social network, it is particularly difficult to scale a crawling system where a single crawling engine is responsible for the frontier. It is also expensive to manage large, persistent versions of frontier and population and the operation of sorting becomes expensive if the frontier has to be written to disk files or database. In some embodiments, social media crawling engine 106 implements a distributed crawl protocol to address such problem, where social media crawling engine 106 comprises a network of multiple sub-crawlers (i.e., distributed crawling processes) so that the frontier is divided amongst the sub-crawlers using a sharing scheme on the IDs of the primary objects. Specifically, each sub-crawler discovers and maintains its own frontier and hands off foreign IDs to other responsible sub-crawlers. The distributed crawl protocol is lightweight and nothing is persisted to disk except the corpus. New sub-crawlers can be introduced into the network and existing sub-crawlers can leave the network at any time.

In some embodiments, social media crawling engine 106 maintains a topology of the network of sub-crawlers, which is a list of slots each containing the address (IP:PORT) of a sub-crawler. When only one sub-crawler is present in the topology, all slots in the topology contain the address of this single sub-crawler. When a sub-crawler starts, it is registered and added to the topology in such a way as to minimize the changes to existing topology and to maximize the distribution of the frontier. Whenever the topology is updated, social media crawling engine 106 connects to and updates every sub-crawler in the topology.

In some embodiments, a sub-crawler runs a HTTP listener and registers its IP address with social media crawling engine 106 at its startup time to indicate its availability. The sub-crawlers may receive two types of messages:

1. topology_update( ) from social media crawling engine 106 when a node is added or removed to the topology;

2. handoff( ) from other sub-crawlers to receive IDs that are in the responsibility of the sub-crawler.

When new IDs are discovered (i.e., an ID not present in the population), a sub-crawler computes HASH(id) that to compute a slot (e.g., between 1 . . . 1024) in the topology for the ID and checks the topology to determine which sub-crawler is responsible for slot. If the sub-crawler owns the slot, the ID goes in the local process chain; otherwise, it reassigns it to the responsible sub-crawler.

In some embodiments, a sub-crawler may discover failed nodes in the network of crawlers when connecting to other sub-crawlers. For a non-limiting example, When a sub-crawler (e.g., SENDER) notices a failed node (e.g., RECIPIENT), it connects and reports to social media crawling engine 106 that RECIPIENT is unreachable. RECIPIENT is then removed from the topology if a ping sent to it fails. If the ping succeeds, SENDER is removed from the topology instead. To exit gracefully from the network, a sub-crawler turns off its listener, sends a unreachable(SELF) to social media crawling engine 106, waits for new topology updated without SELF and then runs an handoff on each item in its frontier.

In some embodiments, the topology of the network of sub-crawlers may change after resources have been added to the frontier. Before retrieving a resource from the frontier via, e.g., HTTP GET, a sub-crawler should determine its locality and do a handoff if the resource is no longer its responsibility. Since hundreds of thousands of locality tests can be done in the time it takes to do one HTTP GET, this strategy ensures optimal use of API allocations provided by the social network even in face of volatile topology.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

1. A system, comprising:
a data collection engine, which in operation,
collects data on past activities of a user on a social network;
establishes a pattern of the past activities of the user on the social network over time based on timestamps associated with the past activities of the user;
a prediction engine, which in operation,
predicts future activities of the user on the social network based on the pattern of the past activities of the user;
determines a collection schedule of the activities of the user based on the predicted future activities of the user;
a social media crawling engine, which in operation, collects activities of the user according to the collection schedule of the activities of the user during crawling of the social network.

2. The system of claim 1, wherein:
the social network is a publicly accessible web-based platform or community that enables its users/members to post, share, communicate, and interact with each other.

3. The system of claim 1, wherein:
the social network is one of Facebook, Google+, Tweeter, LinkedIn, blogs, forums, or any other web-based communities.

4. The system of claim 1, wherein:
activities of the user on the social media network include one or more of posts, comments to other users' posts, opinions, feeds, connections, references, links to other websites or applications, or any other activities on the social network.

5. The system of claim 1, wherein:
each of the activities of the user on the social network has an explicit time stamp associated with the activity.

6. The system of claim 1, wherein:
data of the past activities of the user are collected by the social media crawling engine during previous crawling of the social network over a certain period of time and maintained in a database as past activity records associated with the user.

7. The system of claim 1, wherein:
the pattern of the past activities of the user reflects when the user is most or least active on the social network and the frequency of the user's activities on the social network.

8. The system of claim 1, wherein:
the data collection engine determines whether the user is likely to be most active upon the occurrence of certain events.

9. The system of claim 1, wherein:
the data collection engine determines whether the activities of the user are closely related to the activities of one or more his/her friends the user is connected to on the social network.

10. The system of claim 1, wherein:
the collection schedule of the activities of the user directly relates to the time periods when the user is most active.

11. The system of claim 1, wherein:
the social media crawling engine periodically crawls the social media network to collect the latest data from the user based on the activity collection schedule for the user.

12. The system of claim 1, wherein:
the social media crawling engine skips data collection for the user during the time when he/she is predicted to be less active by the collection schedule of the user.

13. The system of claim 1, wherein:
the social media crawling engine provides the latest activities of the user to the data collection engine in a timely manner.

14. The system of claim 13, wherein:
the data collection engine identifies whether the activities of the user happened certain time ago before they are collected.

15. The system of claim 14, wherein:
the prediction engine updates current predictions or makes new predictions and collection schedules to reflect changed behavior pattern of the user if the data collection engine identifies that the activities of the user happened certain time ago before they are collected.

16. A method, comprising:
collecting data on past activities of a user on a social network;
establishing a pattern of the past activities of the user on the social network over time based on timestamps associated with the past activities of the user;
predicting future activities of the user on the social network based on the pattern of the past activities of the user;
determining a collection schedule of the activities of the user based on the predicted future activities of the user;
collecting activities of the user during crawling of the social network according to the collection schedule of the activities of the user during crawling of the social network.

17. The method of claim 16, further comprising:
collecting data of the past activities of the user during previous crawling of the social network over a certain period of time; and
maintaining the data in a database as past activity records associated with the user.

18. The method of claim 16, further comprising:
determining whether the user is likely to be most active upon the occurrence of certain events.

19. The method of claim 16, further comprising:
determining whether the activities of the user are closely related to the activities of one or more his/her friends the user is connected to on the social network.

20. The method of claim 16, further comprising:
periodically crawling the social media network to collect the latest data from the user based on the activity collection schedule for the user.

21. The method of claim 16, further comprising:
skipping data collection for the user during the time when he/she is predicted to be less active by the collection schedule of the user.

22. The method of claim 16, further comprising:
identifying whether the activities of the user happened certain time ago before they are collected.

23. The method of claim 22, further comprising:
updating current predictions and collection schedules or making new predictions and collection schedules to reflect changed behavior pattern of the user if the activities of the user happened certain time ago before they are collected.
